(19) United States
(12) Patent Application Publication
(10) Pub. No.: US 2007/0192172 A1
(43) Pub. Date: Aug. 16, 2007

(54) Process for recruiting and certifying technician candidates

(76) Inventor: David A. Milman, Jamesville, NY (US)

Correspondence Address: BERNHARD P. MOLLDREM, JR., 224 HARRISON STREET, SUITE 200, SYRACUSE, NY, 13202, US

(21) Appl. No.: 11/353,809

(22) Filed: Feb. 14, 2006

(51) Int. Cl. H04M 3/51

(52) U.S. Cl. 705/11

(57) ABSTRACT

On-line preliminary screening of technician candidates is carried out automatically at a central office and the names of certified technician candidates are provided to businesses, e.g., franchise operators, in the same or nearby geographic location as the candidate. Candidates are directed to an interactive survey of background information. Alternatively, candidates may contact the central office by email and complete an email survey. A candidate with satisfactory background data is provided with an on-line employment or consulting agreement which is to be reviewed and signed electronically. Some sub-parts must be agreed to specifically. Then the candidate downloads a job-related procedure manual, and after studying that, he or she takes an on-line timed examination. If the candidate achieves a satisfactory score, he or she is considered certified, and at that time the name is given to the franchise operator(s). One retake of the examination is permitted.

### BACKGROUND OF THE INVENTION

This invention concerns systems and techniques for recruiting and pre-qualifying persons for job opportunities with any of a number of businesses distributed over a number of geographic locations, e.g., franchises. The invention is more specifically directed to an automated system in which a central business office, e.g., a franchisor location, can advertise for technicians on-line, in print, or in electronic media, prepare the technician candidates for employment at one or more sites, i.e., franchisee business locations, and ensure the technician candidates are willing and qualified. While the invention can be implemented in a franchise setting, the invention is not limited to that and can be applied to other business models.

Currently, business owners and operators are responsible for recruiting their own employees, independent contractor providers, and other assistance. In the case of a franchise, this means each franchisee/operator has to advertise locally, accept inquiries by phone or email from prospective applicants, investigate the background of the applicants, test the applicants, brief them fully on job requirements, test them for performance capabilities, and ensure each one reads, understands, and signs a required employment agreement or consulting agreement. As the terms are used in the description and claims “employment” and “job” are intended to cover both the traditional employer-employee relation and other business relations including consultant and independent contractor. This process consumes an enormous amount of time for the franchise operator, and takes away from the time that could be spent on management and planning. The same problems plague the recruitment process both for traditional statutory employee technicians and for independent contractor technicians.

There have been various techniques proposed for facilitating the recruitment of personnel, one of which is discussed in Cotter Published U.S. Pat. Appln. No. US2004/0107112. Cotter is directed to a computerized method for recruiting and screening job applicants and determining whether applicants are qualified for employment. Cotter's system provides information on-line about employers and posts job openings. The on-line job seeker first seeks an advertised job of interest, then answers a series of pre-screening questions, which are scored, and if the candidate's score is high enough, he or she is considered to be a qualified applicant. This technique covers some of the requirements needed for an on-line technician recruitment system, but fails to recognize at least a few other rather critical factors. For example, the Cotter system does not associate successfully qualified candidates with one or more businesses in different geographical areas, e.g., franchisees, where the candidate is located. The candidate is not required to affirmatively assent that he or she is willing to accept the terms of employment or engagement, as that step is not taken until the technician is interviewed and offered a position. The candidate is tested only on very general technical qualifications, but not tested on specific job proficiency or job requirements for the specific position. These items fall to the business owner operator at or after the time that the technician is hired or engaged, and these can consume much valuable time. The Cotter system does not pre-screen out those technician candidates that are unwilling to accept the terms of engagement or those unable or unwilling to learn the specific skills and requirements for the job position, and so additional time is wasted by the business owner or franchisee in interviewing such candidates.

### OBJECTS AND SUMMARY OF THE INVENTION

Accordingly, it is an object of the present invention to provide a business method or process for on-line recruiting and pre-qualifying technicians for job positions at any of a number of businesses at various geographic locations, where the applicants are pre-screened and certified before being referred to the owners and/or operators of the businesses.

In the case of a franchise operation, for example, it is an object to provide a technique in which the franchisor advertises for qualified technicians, pre-qualifies them as to their education and employment background, ensures that they are willing to sign an employment agreement or engagement agreement, provides the applicants with specific information about the job and specific rules and requirements, tests the applicants on-line concerning those requirements, and then certifies only those candidates that have satisfied the above for employment or engagement by its franchise operators. The process is not limited to franchises.

It is a related object for a central office, e.g., the franchisor central office to attend to all the pre-qualification and certification aspects of recruitment, to simplify the task for the franchise operator (or other business client) in obtaining qualified and productive technicians.

According to an aspect of this invention, the process involves advertising to fill technician positions, e.g., on an Internet web site, and inviting potential candidates to visit the host company or franchiser web site. When the candidate, i.e., applicant visits the web site he or she is taken to the employment screen, the candidate is led through a number of steps on automated screens. First, there is a brief survey for the candidate to list his or her qualifications, which in one favorable embodiment involves three questions. The survey format can have more or fewer than three questions. These concern education levels, employment and related experience, and general background. Alternatively, the survey and responses may be carried out by email, as discussed below. Then, if the candidate meets minimum standards of education, training and experience, he or she goes to a screen where an employment contract or consulting agreement is made available for him or her to read and sign on-line. This provides information about income and job responsibility. There are several specific items, i.e., sub-parts, in the agreement or contract that the candidate is asked to acknowledge by clicking on a box marked “I AGREE” at the appropriate point following, or next to, the clause in question. When the candidate completes this accepting all the required clauses and the entire agreement, and providing authorization for a standard background check, then he or she is provided with detailed information about the job, which in a preferred embodiment involves technician service call procedures. The intention is that the candidate take a couple of days to study this material, so the information is provided in a document that the applicant can download. Then the candidate returns to the web site, and continues the procedure by completing an examination, following the instructions provided. Preferably, the candidate is given a time limit to complete the exam, and in a preferred embodiment, the examination has 30 questions, e.g., multiple choice and true-false, which must be completed in 15 minutes. The test questions are directed to the service call procedures. The test is graded and the test score is automatically recorded.

Alternatively, if a candidate submits a resume (which can be submitted on line or via email) the central office will send the survey electronically (i.e., by email) to the candidate. Then the candidate responds to the survey questions, and submits the response by return email. If the candidate has appropriate background and training levels, the candidate is invited to view the on-line employment agreement or consulting agreement, and the process continues as above from that point.

In a preferred mode, a daily report is automatically generated at the home office, i.e., at the franchisor, and the human resources director reviews this. He or she sends out e-mail responses to the candidates. If the candidate has a score at or above passing, e.g. 76%, then this is a notification that the individual is certified. If the score is below passing, the HR director sends a notice that the score was too low and the candidate should re-study the materials and retake the exam. If the candidate fails twice, then the candidate has to wait (e.g., six months) to re-take the exam. The system automatically identifies the candidate, such as by email address, to exclude him or her from re-applying until the six months have elapsed. For example, the email address is tagged and stored to identify the candidate if he or she re-applies before the six months. The foregoing reports and notifications can also be sent out automatically, if desired.

The names of the qualified candidates are passed on to the franchisee(s) in the candidate's geographical area. At that time, the franchisee contacts the certified candidate to schedule an interview and to check the candidates credentials. An email or other communication sent to the candidate when he or she is certified may also include the name(s) and contact data for franchisee(s) at or near the candidate's location, if it is desired or permitted for the certified candidate to initiate contact.

The central office human resources director has the option of contacting the candidates where there is an obvious problem, such as where the score indicates that the connection was broken during the exam, or where the candidate's answers to the survey question show that a personal e-mail contact would be in order.

A clear advantage of this system over the common practice in recruiting is the saving and time and effort for the franchisee. The franchisee is presented with only well qualified candidates, without having to run advertisements and without having to deal with in-person or phone contacts with poorly qualified persons or with those who would not want to complete the hiring procedure. Because the franchisee only needs to go through the interview phase with the candidates, and because the pool of candidates is limited, this frees up the franchisee to run the business.

This system facilitates independent participation, by directing the best qualified candidates to the business, while requiring only limited knowledge in hiring and recruiting practices on the part of the franchise operator.

The above and many other objects, features, and advantages of this invention will be more fully appreciated from the ensuing description of a preferred embodiment, which is to be read in conjunction with the accompanying Drawing.

### BRIEF DESCRIPTION OF THE DRAWING

FIG. 1 is a flow chart explaining the recruiting procedure according to an embodiment of this invention.

FIG. 2 shows contents of a screen appearing on the monitor as viewed by the candidate or applicant, explaining the process of review and acceptance of the employment contract or consulting agreement.

### DETAILED DESCRIPTION OF THE PREFERRED EMBODIMENT

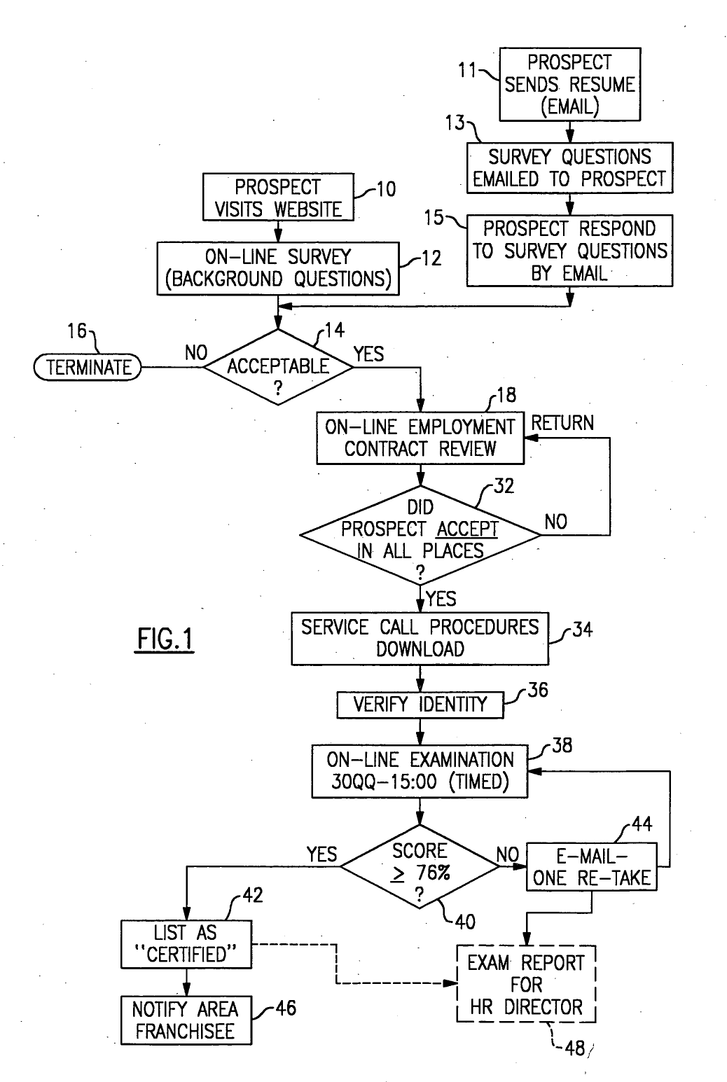

With reference now to the Drawing, FIG. 1 thereof is a flow chart showing the various process steps involved in the technician system according to one embodiment of this invention.

The process is generally controlled from a main office or central station, at a computer or computer server that is connected with a global computer network such as the Internet.

In a preferred embodiment, the central office is operated by a franchisor company that recruits qualified persons with a technical training and background to jobs, either as employees or as independent contractors, at franchises located around the country, or even outside the country. For one example, the franchise operation is intended to provide rapid response computer and network troubleshooting and repair, and the franchise recruits qualified computer and network technicians for its affiliated franchisee companies. In other possible embodiments, the process can be used by a recruiting company or by a large corporation for its branch offices.

The franchisor polls its franchisees on a continual basis to track technician needs. The technician positions are advertised either in classified newspaper advertisements, or on-line on the Internet through a job posting service, or through any other means, including word of mouth. The advertisements instruct interested persons to contact the company by visiting the company web site, where the prospective recruits are directed to an “employment” page. There are more complete instructions on that page for becoming certified as a technician and eligible to be placed in a technician job position at a franchisee company.

When the prospect visits the employment web page [block 10], he or she is directed to complete an interactive survey [block 12], which may consist of three questions concerning the person's technical experience and education and employment. Favorably, one of the survey questions concerns the level of education attained (high school, some college, associate degree, bachelors degree), and another question can involve experience (numbers of computer systems, networks, and servers installed, for example). Another question can involve general personal background issues. In a preferred mode, each of these questions has a multiple of possible answers, and the prospect or candidate clicks on (or selects) the response that corresponds to the prospects own background. These questions favorably would each have three or more possible responses. The various responses for each question are have different weights, and the three weighted responses are combined to create an overall score. This is compared with what is considered an acceptable level [block 14]. If the score for the survey questions is too low [block 16], the prospect is notified and the recruiting session is terminated at that point. In practice, the system notifies the prospective candidate of this by email, with an explanation. On the other hand, if the survey question score is acceptable, the prospect is invited to review and complete an employment contract on-line [block 18]. At this point, a screen appears that thanks the prospect for taking the time to become a Certified Consultant, and instructs the prospect in how to review and sign (electronically) the contract. The system instructs the prospect or candidate to click on a link to view the Consultant Agreement, and gives further instructions about particular sections or clauses in the agreement that need to be specially agreed to.

Alternatively, when a prospect or candidate sends his or her resume, i.e., by electronic mail or email, to the central office [block 11], the central office sends the candidate a return email [block 13] that contains the survey questions, and instructions about responding. The candidate completes the survey questions, and sends his or her response by return email [block 15] to the central office. At that point, the candidate's response is evaluated as described above [block 14], and if the candidate's background education and experience are at satisfactory levels or better, the process continues as described above, commencing with the on-line review of the employment contract [18]. If the candidate's survey response indicates that he or she does not meet satisfactory background levels, then the candidate is so notified and the session is terminated [16].

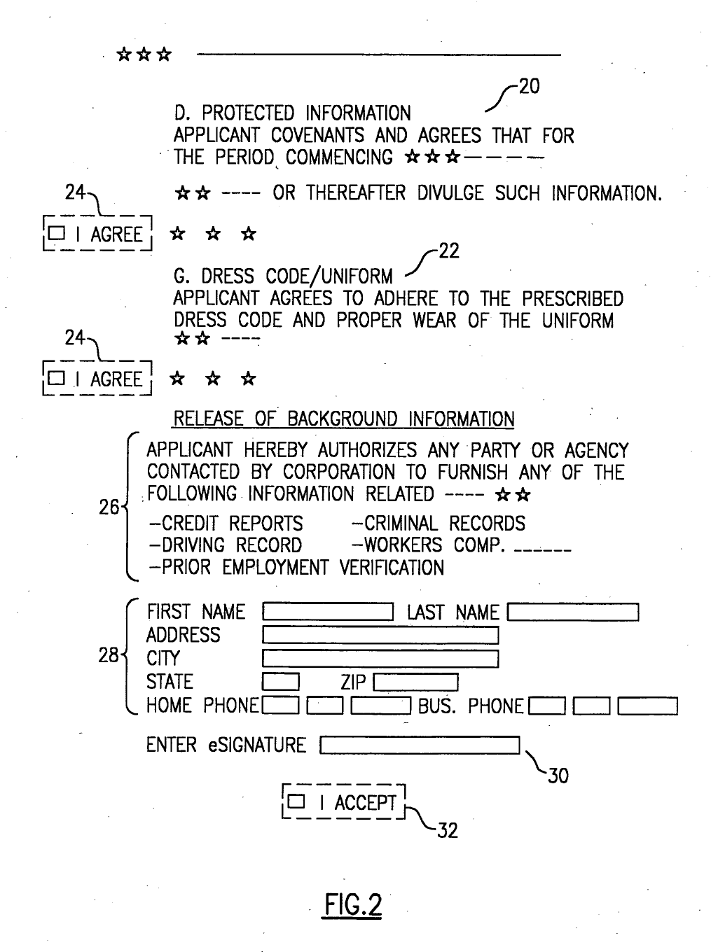

FIG. 2 illustrates generally how one version of the Consultant Agreement appears on the screen for the candidate to review. In addition to various general work related conditions, confidentiality, and other clauses relating to the scope of the job, etc., the Agreement may have a number of clauses or sub-parts where it is important to ensure that the candidate has considered and agreed to those terms specifically. As two examples, one contract clause [20] concerns how company and customer information is to be protected and safeguarded, and another clause [22] concerns requirements for appearance and dress. At the location of each of these clauses [20], [22], on the left hand side of the screen, there are check boxes [24]. In order to complete the certification process, the candidate is required to affirmatively agree to each of those clauses, by selecting “I AGREE” at each of the check boxes [24]. There may be several other specific clauses that require affirmative agreement by the candidate, and each of these will also be provided with a similar check box (in the left margin in this example).

At the end or bottom of the contract is a notice [26] that the candidate is agreeing to release of background information, such as credit reports, driving record, verification of prior employment, criminal record if any, workers comp claims, or other items as may be specified. Below this are spaces [28] for the candidate to complete the agreement by entering his or her complete name, full address (city, state, five-digit ZIP), and contact telephone numbers (home, office, cell). Then the candidate enters an electronic signature in a space provided [30] below the spaces [28], and then indicates acceptance by clicking on an “I ACCEPT” check box [32].

If any of the required acceptances or agreements are omitted, a “pop-up” box displays, indicating the details about what acceptance or agreement is missing. The candidate can then scroll back to that part of the document, and review and accept that portion by clicking on the check box [24]. Returning to FIG. 1, this portion of the process is represented by box [34]. The candidate must indicate a willingness to comply with the terms of the Consultant Agreement, including all the specific clauses accompanied by the click box [24], before being allowed to continue with the recruitment process.

Once the candidate has completed this step [34] and has successfully agreed to the Consultant Agreement, the central office e-mails the candidate with a copy of the signed agreement, and a copy of the system Service Call Procedures, and a link to an on-line examination for testing the candidate's proficiency on the Service Call Procedures. As an option, the central office may wait to send the Service Call Procedures and the link to the exam until the items in [26] are obtained and after verification and background check have been carried out.

The Service Call Procedure is provided as an electronic document that the candidate can download [step 34] and print out so it can be thoroughly reviewed and studied. When the candidate feels he or she is ready, the candidate follows the instructions for reaching the on-line exam. At this point, the system verifies the identity of the candidate [step 36] checking the candidate by email address and/or other furnished information. Then the candidate commences with the on-line exam [38]. While this embodiment uses Service Call Procedures for this phase, other job-related procedures can be used for other recruiting and screening systems.

In one preferred version, the on-line exam consists of thirty questions, which are multiple-choice and true-false concerning details contained in the Service Call Procedures. The candidate has fifteen minutes to complete all thirty questions, and the session automatically terminates at the fifteen-minute point.

After the end of the examination session, the candidate's answers are automatically graded and the resulting test score is recorded. In a preferred implementation, a score of 76 percent or higher is considered passing (corresponding to 23 correct answers or more), and the candidate's recorded test score is compared with this threshold score [block 40]. The automated grading and notification of test results takes place within the next 48 to 72 hours after completing the exam. If the candidate has achieved a score equal to or exceeding the minimum passing score, the central office notifies the candidate by email that he or she in now Certified as a consultant and is ready to be interviewed for job position at one (or more) of the franchisee locations [box 42].

On the other hand, if the candidate fails to achieve a passing score, the candidate is notified of that, and is notified that he or she is allowed to re-take the examination [box 44]. In this implementation, one re-take is permitted, and if the candidate has failed two times, then the candidate is not permitted to take the on-line examination again for a period of six months. In other possible implementations, two or more re-takes may be permitted. In the case of a failing score, the system tags the candidate identity (e.g., his or her email address) to ensure that the candidate is permitted only the one re-take.

A list of certified candidates is provided regularly to the franchise operators in the areas where the certified candidates are geographically located and also to franchise operators in adjacent or nearby areas [block 46]. This information can also be conveyed by email at the time that the candidate is notified.

The system also generates periodic reports, i.e., daily reports, of recruiting activity [block 50] and these are provided to the recruitment director or human resources director at the central office. These include at a minimum the identities of the candidates completing the on-line examination and their respective scores. The recruitment director can intervene in the process at any time, for example, in the case of an exceptionally low test score or failure to complete the examination, which may indicate a lost connection. Also, the recruitment director can also review candidates' answers to the survey questions [12], and may contact the candidate by email if that action appears appropriate.

With the process as described, the franchise operators are provided the names and contact information of certified candidates, i.e., those who have an appropriate background, who have agreed to the terms of the Consultant Agreement, and who have shown a competence and understanding of the Service Call Procedures that they are expected to observe on the job. As a result, the pool of potential candidates is narrowed down to those which will have a high likelihood of success in the job position. This frees the franchise operator from many hours that he or she would ordinarily need to devote to recruiting, and that time can be spent in conducting other aspects of the business.

The process may be used for selecting or pre-qualifying candidates for many types of job positions in many fields of business, whether as consultants or normal direct employees.

While the invention has been described with reference to a specific preferred embodiment, the invention is certainly not limited to that precise embodiment. Rather, many modifications and variations will become apparent to persons of skill in the art without departure from the scope and spirit of this invention, as defined in the appended claims.

1. Automated process for recruiting technicians and pre-certifying them for a job position with any of a number of business owners in distributed over a number of different geographical locations to ensure that technician candidates presented to said business owners are willing and qualified; the process comprising;
a. advertising for technician candidates to contact a host screening and certifying facility;
b. accepting background information from the candidate including geographic location and background qualification data relevant to the job position;
c. analyzing the background information accepted from said candidate to determine if said candidate meets at least minimum qualifications for said job position;
d. if the background qualification data so analyzed indicate that the candidate does meet the minimum qualifications, providing at a host facility web site on a global computer network an on-line employment agreement for said candidate to read and sign; said agreement including a plurality of sub-parts which are directed to respective items of job responsibility, and which are to be individually and separately agreed to by the candidate;
e. providing a plurality of acceptance blocks within the on-line employment agreement, each associated with a respective sub-part of said on-line employment agreement, and an acceptance block associated with the entire on-line employment agreement, for permitting said candidate reviewing said agreement and said sub-parts on-line for the candidate to affirmatively agree to the entire agreement and to each of said sub-parts, respectively;
f. ensuring that the candidate has agreed to each said sub-part and to said entire agreement;
g. if the candidate has agreed on-line to the entire agreement and to said sub-parts, then providing the candidate with an on-line document containing detailed information concerning procedures for said Job position that the candidate is expected to observe on the job;
h. thereafter, providing said candidate with an on-line examination concerning said procedures for said job position, including a predetermined set of test questions, wherein said candidate completes said examination by answering said test questions on line;
i. automatically scoring said on-line examination and recording a test score for said candidate;
j. comparing said test score with a predetermined passing threshold;
k. if said test score is below said passing threshold, notifying said candidate of failure to pass said examination;
l. if said test score equals or exceeds said passing threshold, notifying said candidate of success in obtaining certification for said job position; and
m. providing identification data of said candidate haying obtained certification to one or more of said business owners in or near the geographic location of the candidate.

2. Process according to claim 1, wherein said step of accepting background information includes leading the candidate to an employment screen at said host facility web site; and providing an interactive survey screen for said candidate to enter identification information including geographic location, the survey screen including a set of survey questions to obtain background qualification data relevant to said job position concerning said candidate.

3. Process according to claim 2, wherein said interactive survey screen contains three questions, each having at least three possible responses, with said candidate responding to said survey questions by selecting one of said at least three responses for each of said questions.

4. Process according to claim 3, wherein the step of analyzing background information comprises analyzing of the responses of the candidate to the survey questions, including weighting the responses to the questions and combining weights of the responses to determine whether the candidate meets at least the minimum qualifications.

5. Process according to claim 1, wherein the step of accepting background information includes accepting a resume submitted electronically.

6. Process according to claim 5, further comprising sending the candidate by electronic mail a set of survey questions to obtain background qualification data relevant to said job position concerning said candidate, and accepting responses to said survey questions from said candidate transmitted by return electronic mail.

7. Process according to claim 6, wherein the set of survey questions contains three questions, each having at least three possible responses, with said candidate responding to said survey questions by selecting one of said at least three responses for each of said questions.

8. Process according to claim 6 wherein the step of analyzing background information comprises analyzing of the responses of the candidate to the survey questions, including weighting the responses to the questions and combining weights of the responses to determine whether the candidate meets at least the minimum qualifications.

9. Process according to claim 1, wherein said acceptance blocks are configured to permit the candidate to enter an acceptance by clicking on the respective block.

10. Process according to claim 1, wherein said job positions require skills as service technicians, and said on-line document includes a manual of service call procedures.

11. Process according to claim 1, wherein the step of providing the candidate with an on-line examination includes limiting the time for the candidate to complete the examination.

12. Process according to claim 1, comprising automatically generating an internal report of all candidates who have completed the on-line examination during a time period, together with their respective test scores.

13. Process according to claim 1, in which if the test score of said candidate is below the threshold, permitting the candidate one re-take of the examination in which the candidate completes the examination on-line by answering said test questions, the process then automatically scoring said on-line examination and recording the test score for the re-take by the candidate, and if the candidate fails to achieve a test score above said threshold, tagging the candidate identity so as to deny another re-take for at least a predetermined period of time.

14. Process according to claim 1 in which said on-line employment agreement includes a release clause authorizing release of candidate background information.

15. Process according to claim 14, comprising obtaining said candidate background information prior to providing the candidate with said on-line examination.

16. Process according to claim 1, wherein said business owners are franchisees of a common franchise business, and wherein said employment agreement, said on-line document, and said on-line examination are identical in respect to all of the above-mentioned business owners.
